(19) United States
(12) Patent Application Publication
(10) Pub. No.: US 2008/0034427 A1
(43) Pub. Date: Feb. 7, 2008

(54) FAST AND SCALABLE PROCESS FOR REGULAR EXPRESSION SEARCH

(75) Inventors: Srihari Cadambi, Cherry Hill, NJ (US); Srimat T. Chakradhar, Manalapan, NJ (US); Michela Becchi, St. Louis, MO (US)

Correspondence Address: NEC LABORATORIES AMERICA, INC., 4 INDEPENDENCE WAY, Suite 200, PRINCETON, NJ, 08540, US

(73) Assignee: NEC Laboratories America, Inc., Princeton, NJ (US)

(21) Appl. No.: 11/830,487

(22) Filed: Jul. 30, 2007

Related U.S. Application Data
(60) Provisional application No. 60/821,192, filed on Aug. 2, 2006.

(51) Int. Cl. G06F 11/00

(52) U.S. Cl. 726/22

(57) ABSTRACT

A method includes reducing a deterministic finite automata DFA representative of an expression to provide a smaller DFA, and subjecting information that matches the smaller DFA to non-deterministic finite automata NFA representative of the expression for reducing memory required for pattern matching of the information.

This application claims the benefit of U.S. Provisional Application No. 60/821,192, entitled “Memory-Efficient Regular expression Search for Intrusion Detection”, filed on Aug. 2, 2006, the contents of which is incorporated by reference herein.

### BACKGROUND OF THE INVENTION

The present invention relates generally to regular expression matching using deterministic finite automata crucial to network services such as intrusion detection and policy management, and, more particularly, to a fast and scalable process for regular expression search.

Pattern matching is a crucial task in several critical network services such as intrusion detection and policy management. As the complexity of rule-sets continues to increase, traditional string matching engines are being replaced by more sophisticated regular expression engines. To keep up with line rates, deal with denial of service attacks and provide predictable resource provisioning, the design of such engines must allow examining payload traffic at several gigabits per second and provide worst case speed guarantees. While regular expression matching using deterministic finite automata (DFA) is a well studied problem in theory, its implementation either in software or specialized hardware is complicated by prohibitive memory requirements. This is especially true for DFAs representing complex regular expressions present in practical rule-sets.

In addition to examining structured information present in the header to classify a packet, many critical network services such as intrusion detection (IDS), policy management and identification of P2P traffic, require inspection of packet payloads. Also known as deep packet inspection, this provides better capability to classify packets based upon applications, content and state. Until recently, rule-sets for intrusion detection and other services primarily consisted of strings. However, many current known rule-sets are replacing strings with the more powerful and expressive regular expressions.

The classical method to perform regular expression search is to use a deterministic finite automaton (DFA), a key aspect of this invention. The main problem with DFAs is prohibitive memory usage. The number of states in a DFA scale poorly with the size and number of wildcards in the regular expressions they represent. As the number of wildcards in a regular expression grows, the number of DFA states increases sharply, exponentially in some cases. The presence of wildcards, one of the primary reasons why regular expressions are so expressive, also complicates merging multiple regular expressions. Two regular expressions with a moderate number of DFA states when considered individually may combine to form a composite DFA with a much larger state count. Since rule-sets typically consist of many regular expressions, it is beneficial to create a combined DFA since checking individual DFAs one-by-one imposes sequentiality in the processing, and decreases speed. This memory complexity makes software regular expression search engines extremely slow and not scalable to large rule-sets. It also makes hardware architectures difficult to design and implement.

Compounding this issue is the fact that critical network services such as intrusion detection must be performed online at high speeds. For a variety of reasons including router design, denial-of-service attacks and resource provisioning, routers must provide a worst-case speed guarantee. In the case of a DFA, this speed guarantee translates to an upper bound on the number of states visited for every input character in the payload traffic. Classical DFAs visit exactly one state per input character. However, due to memory limitations, many DFA generators such as Flex build DFAs with fewer states, and rollback and revisit characters in the input multiple times. Such a strategy is unacceptable for critical, online network services.

Prior work done with deterministic finite automata DFA includes a delayed deterministic finite automata (D2FA) technique, shown 10 in FIG. 1, discussed in a publication entitled, “Algorithms to Accelerate Mutliple Regular Expressions Matching for Deep Packet Inspection”, by Kumar, Dharmapurikar, Yu, Crowley and Turner in proceedings of ACM SigComm 2006. The left portion 11 of FIG. 1 shows a DFA and the right portion 12 shows the D2FA.

Unlike the inventive approach, D2FA does not merge states or label transitions. Rather it identifies two (or more) states that transition to the same set of destinations on the same input characters. For example, if both states S0 and S1 transition to state S2 on character “a” and to state S3 on character “b”, then the “a” and “b” transitions of state S1 are removed and replaced by a single .default. transition to state S0. Upon reaching S1, if the input is “a” or “b”, the default transition is taken to S0 and then transition to the appropriate destination state. Thus, D2FA achieves memory compaction by removing duplicated transitions, but this happens at the expense of latency; states with a default transition require more than one transition per input character.

There are two major differences between the inventive technique and D2FA. First, D2FA requires target states to have the same destinations as well as the same character to transition to those destinations. The inventive technique does not have this restriction, and can merge states with common destinations, regardless of the characters on which they transition to those destinations. In other words, the states that D2FA targets are a subset of the states that the inventive technique can merge. Second, with the inventive technique, merging states creates opportunities for more merging. By contrast, D2FA is a static technique.

Another known technique in the deterministic finite area DFA is the Real-time DFA (RDFA) disclosed in U.S. Pat. No. 6,856,981 ('981) and shown 20 in FIG. 2. The core idea of the RDFA is to process multiple bytes of the input in parallel. In state diagram 22, 4 bytes are processed in parallel, rather than the serial processing shown in state diagram 21. In the worst-case, this can drastically increase the already high DFA memory requirement. For instance, each state can possibly have 256⁴ next states! However, the '981 patent assumes that such situations are rare, and designs the RDFA architecture based on that assumption. Under the assumption, the key idea the '981 patent proposes is that of character classes defined for sets of states. For example, suppose we start from state s0 and after reading 2 characters, are in any of the states {s1, s2, s3}. Now consider “a”, “b” and “c” for the third character. If “a” can take us from s1 to s4 or from s2 to s5 (depending on whether we were in s1or s2 to begin with), the set of transitions associated with “a” is {s1→s4, s2→s5}. Say the transitions associated with “b” and “c” are {s2→s7} and {s1→s4, s2→s5}. Then “a” and “c” are mapped to the same character class owing to an identical set of transitions.

When 4 bytes are read in parallel, the '981 patent architecture reads 4 character classes from 4 different memory blocks, concatenates the 4 character classes together with the current state, and produces an address into a next state table. Under the assumption, the ‘'981 patent claims that the number of character classes and all the memory blocks is typically small thereby achieving compression in the DFA representation. Note that the '981 patent does not address the fact the number of states in a DFA is large to begin with. The '981 patent teachings only attempt to enhance the performance by reading multiple characters at the same time.

Another related DFA technique is disclosed in a work entitled “Processing XML Streams with Deterministic Automata and Stream Indexes,” by T. J. Green, A. Gupta, G. Miklau, M. Onizuka, and D. Suciu, ACM TODS, vol. 29, 2004. These authors propose constructing a DFA lazily, on the fly, specifically for processing XML streams. To begin with, the DFA has only one state. As inputs arrive, additional states are built on demand. The primary differences between the present inventive reduced DFA and the lazy DFA are: (i) the inventive technique builds the reduced DFA statically by profiling the input traffic and (ii) the invention uses an NFA to resolve false matches from the reduced DFA.

As noted above, classically, regular expression matching is performed using deterministic finite automata (DFA) or non-deterministic finite automata (NFA). DFAs are very fast (O(1) processing time per input character), but their implementation either in software or specialized hardware is complicated by prohibitive memory requirements. This is especially true for DFAs representing complex regular expressions present in practical rule-sets. NFAs on the other hand are compact but slow—their processing time per input character is O(n), where n is the total size of the regular expressions.

Accordingly, there is a need for addressing memory blow-up of DFAs and the slow speed of NFAs.

### SUMMARY OF THE INVENTION

In accordance with the invention, a method includes reducing deterministic finite automata (DFA) representative of an expression to provide a smaller DFA, and subjecting information that matches the smaller DFA to non-deterministic finite automata NFA representative of the expression for reducing memory required for pattern matching of the information. Preferable, the smaller DFA can produce false positives and no false negatives. In an alternative embodiment, the reducing of the DFA includes sate merging where at least two non-equivalent states in the DFA are merged into a single state using transition labels.

In another aspect of the invention, a method includes removing states from a discriminate finite automata DFA for deriving a smaller DFA that can produce false positives and no false negatives, building a non-discriminate finite automata NFA, and subjecting packet information that matches the DFA to a check by the NFA for pattern matching that combines processing rate of the DFA with memory requirements of the NFA.

In a yet further aspect of the invention, a method subjecting network information to pattern matching combining reduced deterministic finite automata DFA producing false positives and no negatives followed by non-deterministic finite automata NFA for detecting network information that is malicious.

### BRIEF DESCRIPTION OF DRAWINGS

These and other advantages of the invention will be apparent to those of ordinary skill in the art by reference to the following detailed description and the accompanying drawings.

FIG. 1 shows state diagrams illustrating delayed deterministic finite automata (D2FA) according to the prior art.

FIG. 2 shows state diagrams illustrating real time deterministic finite automata (RDFA) according to the prior art.

FIG. 3A is a state diagram of a deterministic finite automata (DFA) representing the expression (a [b-e] [g-i]| f [g-h]j) k+.

FIG. 3B is a state diagram illustrating a state merged equivalent of the DFA in FIG. 3A, in accordance with the invention.

FIG. 4 depicts state diagrams illustrating abstracting a DFA so that the resulting smaller DFA can produce false positives but no false negatives, in accordance with the invention.

FIG. 5 is a block diagram illustrating a hybrid finite automata (FA) having the performance of a deterministic finite automata (DFA) and the memory requirements of a non-deterministic finite automata (NFA), in accordance with the invention.

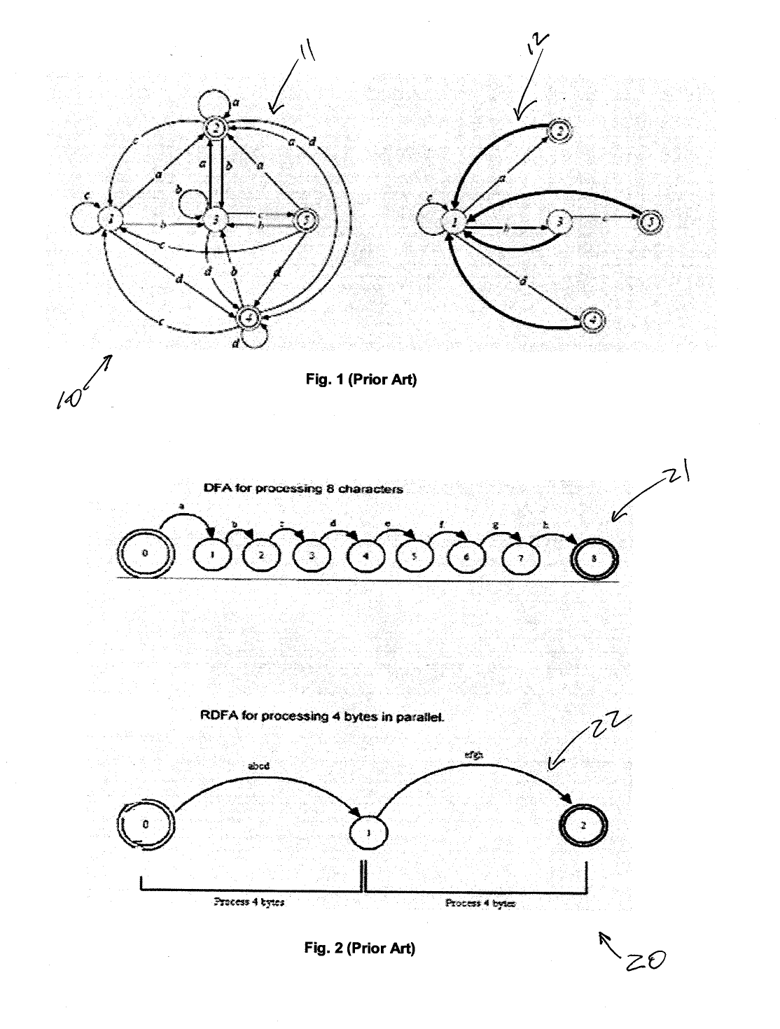

### DETAILED DESCRIPTION

The invention addresses the memory blow-up of deterministic finite automatas DFAs and the slow speed of non-deterministic finite automatas NFAs. One aspect of the invention is reduction of a DFA, such as state merging, where two or more non-equivalent states in a DFA can be merged into a single state using transition labels. Coupled with an enhanced data structure, this merger compresses the DFA by an order of magnitude in practice. The second aspect of the invention is an abstracted hybrid automaton where a DFA is abstracted and combined with an NFA to build an automaton that has the speed of a DFA and the compactness of an NFA.

State Merging. The inventive state merging is a technique that allows non-equivalent states in a DFA to be merged using a scheme where the transitions in the DFA are labeled. By carefully labeling transitions, in effect, we are transferring information from the nodes to the edges of the graph representing the DFA. A data structure for representing a DFA with merged states and labeled transitions is a lossless compression method that can achieve significant memory reductions in practice.

Two or more states in a DFA or NFA can be merged into a single state by introducing labels on their transitions. For every transition connecting two merged states, we define source labels and destination labels. A transition, represented by c.l_{d}/l₀,l₁ . . . , thus has three attributes: (1) a character c upon which the transition is taken; (2) a single destination label Id that indicates to the destination state which underlying original state this transition is meant for; and (3) one or more source labels l₀,l₁ . . . that indicate to the source state upon which label to take this transition.

Each time a transition c.l_{d}/l₀,l₁ . . . is taken, a label Id is produced and stored. Transition c.l_{d}/l₀,l₁ . . . will be taken if the current input character is ‘c’ and the stored label is any of l₀,l₁. . . . If either the source or destination states are not merged, those labels are absent from the transition. Clearly, labels cause an overhead in terms of memory since they need to be stored. The number of required labels is bounded and small, and therefore their introduction only marginally affects memory usage. Such a transformation on the DFA is legal and does not affect correctness. FIGS. 3A and 3B show an example of the state merging transformation on a DFA. The DFA on the right 30B is the state-merged equivalent of the original DFA on the left 30A. Transition labels are the “.0” and “.1” in the “a.0” and “f.1” labels indicated by reference arrows and the merged state S1_{—}2 is indicated by reference arrows.

Merged-state DFAs can be realized in two major ways. First, they can be realized purely in software. It has been demonstrated that, for real security rule-sets, state merging can reduce software memory requirements by 10× over basic data structures, and by over 2× over the more advanced bitmap-based data structure. The bitmap-based data structure is discussed in more detail in priority claimed U.S. Provisional Application No. 60/821,192, entitled “Memory-Efficient Regular expression Search for Intrusion Detection”, filed on Aug. 2, 2006, the contents of which is incorporated by reference herein.

Second, they may be realized using specialized hardware, implemented using field programmable gate arrays (FPGAs) or custom chips. The specialized hardware consists of a lookup table to implement the state-to-next-state mapping of the DFA. With specialized hardware, the memory reduction possible is over 10×. In addition to this, there is a considerable reduction in the hardware logic complexity.

Hybrid Finite Automata. Two key ideas are used to realize hybrid finite automata. The first is the notion of “abstracting a DFA” to build a smaller DFA that allows false positives in a regulated manner. The second is the well-known architectural principle of “making the common-case fast”. We describe these below.

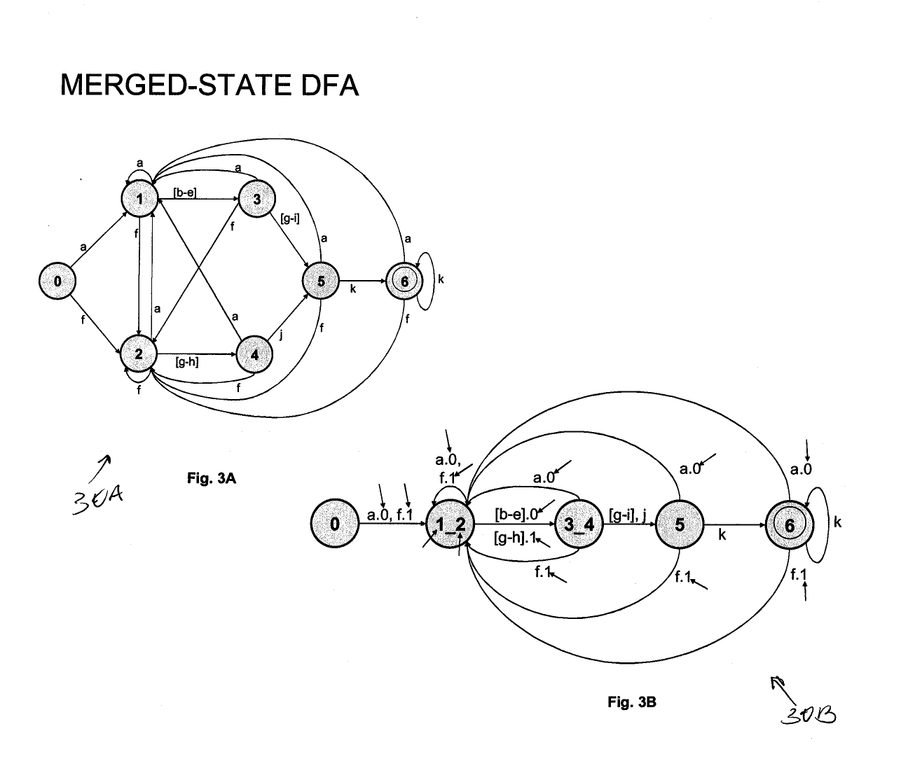

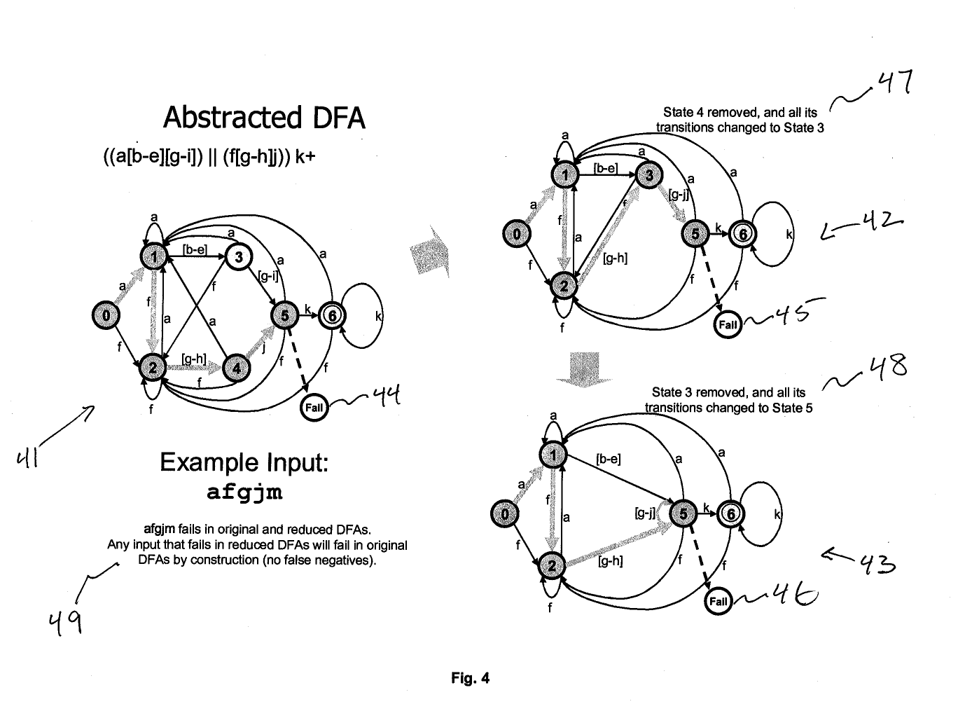

DFA Abstraction. The goal of DFA abstraction is to remove states from the DFA in such a manner that the resulting, smaller DFA can produce false positives but no false negatives. The state diagrams 41, 42, 43 of FIG. 4 show an example. From the original DFA 41, state 4 is removed, and all its transitions changed to state 3 (see reference 47 in FIG. 4) resulting in the first abstracted DFA 42. From the first abstracted DFA 42, state 3 is removed, and all its transitions changed to state 5 (see reference 48 in FIG. 4) resulting in the second abstracted DFA 43. Notice how the example input “afgjm” fails 44 in the original DFA 441, and must fail 45, 46 in all the abstracted DFAs 42, 43 (by construction) to avoid false negatives 49.

For the purpose of outlining how to systematically build a reduced DFA, let d be the transition function of the DFA, and d(S, c) indicate the state to which state S transitions to upon receiving input character c. We want to find two states A and B such that, for all possible strings w, d(A, w) is an accepting state if d(B, w) is an accepting state. Once we find A and B, we move B's incoming and outgoing transitions to A and then delete B. The resulting DFA can have false positives but no false negatives.

While in practice it may not be possible to build a reduced DFA with no false negatives, we propose a probabilistic approach where the reduced DFA will have very few false positives and very few false negatives. We do this by profiling the input traffic and removing those transitions from the original DFA that have the least likelihood of being traversed. This may be done during a training period. After the training period, the reduced DFA that is built may be deployed. During operation, if a transition that was removed is traversed, we revert to the NFA for resolution.

One method of realizing the above reduced DFA is to maintain an additional bitmap for each state. (Refer to the bitmap discussion/references provided before). The new bitmap tells us which transition was removed. For example, in a 4-character alphabet, if state S0 had valid transitions on characters a, b and c, it's bitmap would be 1110. If we remove transition c during training, the second bitmap would be 0010. The third bit being ‘1’ indicates that transition c was present in the original DFA but removed (so we must consult the NFA if this transition is traversed).

A DFA provides high performance (O(1) processing time per input character) but can require considerable memory (up to O(2ⁿ), where n is the number of characters in the regular expression). On the other hand, an NFA is slow (up to O(n) time per input character), but has small memory requirements (O(n)). The goal is to build a hybrid finite automata (FA) that combines the benefits of both an NFA and DFA. In other words, the hybrid FA aims to have the performance of a DFA and the memory requirements of an NFA.

We realize this by combining an reduced DFA with an NFA in such a manner that all matches from the DFA (including false positives) are checked by the NFA. In networking security applications where very few packets contain malicious information, matches will be few and far between. Therefore most of the packets will be processed quickly by the abstracted DFA, and a few will be checked by the slower NFA. Since the abstracted DFA is typically much smaller than a regular DFA, overall memory requirements are mitigated.

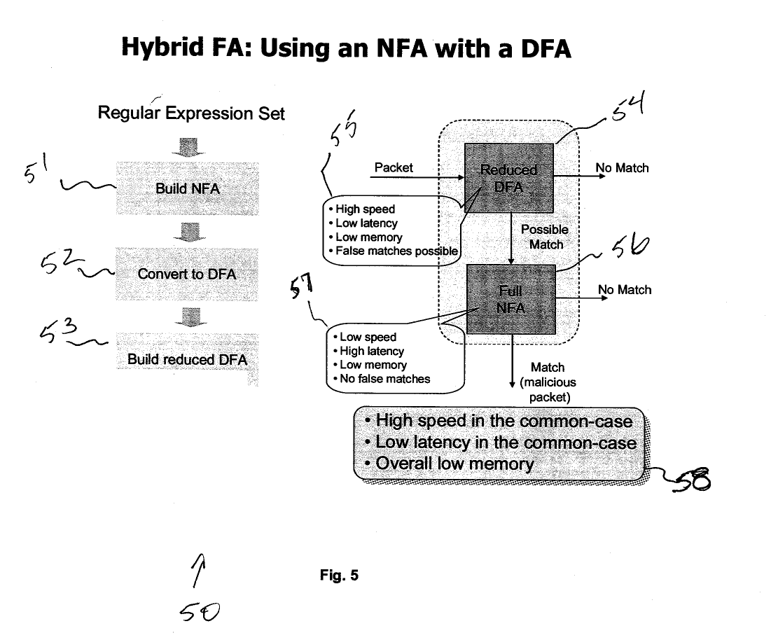

The block diagrams 50 of FIG. 5 detail the hybrid FA in accordance with the invention. A non-deterministic finite automata NFA is built from a regular expression set 51. The expression is converted to a definite finite automata DFA 52 from which a reduced DFA is built 53. A packet payload can be inspected by the reduced DFA and passed through if no match is found. As noted previously, the reduced DFA build allows for high speed, low latency, and low memory but the possibility of false matches 55. If a possible match is found, the packet is inspected by the full NFA 56. The full NFA build allows for low speed, high latency, low memory and no false matches. If there is no match in the full NFA build 56 then the packet payload is passed through. However, if a match is found then a malicious packet has been identified and a potential intrusion may have been detected. The advantages of the combined NFA with a DFA are a high speed in the common-case, low latency in the common-case and overall low memory.

In summary, the invention teaches reducing a DFA is to decrease the memory usage by removing states and transitions. In doing so, we try to MINIMIZE false positives and false negatives. In the ideal case, we want no false negatives, but this may not be practically achievable. The two methods of reducing a DFA are: (i) state merging with transition labeling and (ii) deleting states and transitions based on their probabilities (obtained by profiling network traffic). A reduced DFA, however it is generated, is always coupled with an NFA. When we encounter a false positive or a false negative, we resolve it using the NFA.

The present invention has been shown and described in what are considered to be the most practical and preferred embodiments. It is anticipated, however, that departures may be made therefrom and that obvious modifications will be implemented by those skilled in the art. It will be appreciated that those skilled in the art will be able to devise numerous arrangements and variations which, although not explicitly shown or described herein, embody the principles of the invention and are within their spirit and scope.

What is claimed is:

1. A method comprising the steps of:
reducing a deterministic finite automata DFA representative of an expression to provide a smaller DFA, and
subjecting information that matches said smaller DFA to non-deterministic finite automata NFA representative of said expression for reducing memory required for pattern matching of said information.

2. The method of claim 1, wherein said smaller DFA can produce both false positives and false negatives.

3. The method of claim 2, wherein said false positives and false negatives are resolved using said NFA.

4. The method of claim 1, wherein said smaller DFA can produce false positives and no false negatives.

5. The method of claim 4, wherein said reducing said DFA comprises building a reduced said DFA according to:
(i) where d is a transition function of said DFA,
(ii) d(S,c) indicate the state to which S transitions to upon receiving input character c,
(iii) finding two sates A and B such that, for all possible strings w, d(A,w) is an accepting state if d(B,w) is an accepting state, and
(iv) once finding A and B, moving B's incoming and outgoing transitions to A and then deleting B.

6. The method of claim 4, wherein said information is packet information and matching of said packet information to both said smaller DFA and said NFA is indicative of a malicious packet.

7. The method of claim 1, wherein said reducing of said DFA comprises sate merging where at least two non-equivalent states in said DFA are merged into a single state using transition labels.

8. The method of claim 7, wherein said state merging is a non-lossy transformation of the original DFA producing neither false positives nor false negatives.

9. The method of claim 7, wherein said sate merging of said DFA is realized in at least one of software and hardware for reducing memory requirements.

10. The method of claim 9, wherein said hardware comprises a look up table for implementing state-to-next-sate mapping of said DFA.

11. A method comprising the steps of:
removing states from a discriminate finite automata DFA for deriving a smaller said DFA that can produce false positives and no false negatives,
building a non-discriminate finite automata NFA, and
subjecting packet information that matches said DFA to a check by said NFA for pattern matching that combines processing rate of said DFA with memory requirements of said NFA.

12. The method of claim 11, wherein said step of removing said states comprises building a reduced said DFA according to an outline where:
(i) d is a transition function of said DFA,
(ii) d(S,c) indicate the state to which S transitions to upon receiving input character c,
(iii) finding two sates A and B such that, for all possible strings w, d(A,w) is an accepting state if d(B,w) is an accepting state,
(iv) once finding A and B, moving B's incoming and outgoing transitions to A and then deleting B.

13. The method of claim 11, wherein matching of said packet information to both said smaller DFA and said NFA is indicative of a malicious packet.

14. A method comprising the steps of:
subjecting network information to pattern matching combining reduced deterministic finite automata DFA producing false positives and no negatives followed by non-deterministic finite automata NFA for detecting network information that is malicious.
